(19) United States
(12) Patent Application Publication
(10) Pub. No.: US 2018/0193752 A1
(43) Pub. Date: Jul. 12, 2018

(54) ELECTRONIC DEVICE FOR PROVIDING GAME SERVICE AND OPERATING METHOD THEREOF

(71) Applicant: Samsung Electronics Co., Ltd., Suwon-si (KR)

(72) Inventor: Tae-Hoon LEE, Bucheon-si (KR)

(21) Appl. No.: 15/863,524

(22) Filed: Jan. 5, 2018

(30) Foreign Application Priority Data
Jan. 6, 2017 (KR) 10-2017-0002229

(51) Int. Cl. A63F 13/65; A63F 13/216; A63F 13/358; A63F 13/85; A63F 13/92; A63F 13/55; A63F 13/53; A63F 13/25; A63F 13/352; A63F 13/428; A63F 13/69; A63F 13/79

(52) U.S. Cl. CPC A63F 13/65; A63F 13/216; A63F 13/358; A63F 13/85; A63F 13/92; A63F 13/55; G06Q 30/0601; A63F 13/25; A63F 13/352; A63F 13/428; A63F 13/69; A63F 13/79; A63F 13/53

(57) ABSTRACT

The present disclosure relates to providing a game service using a location-based service in an electronic device, and the electronic device includes: a communication unit configured to communicate with at least one client; a memory configured to store a game management policy; and a processor configured to generate an event based on a location of the at least one client using a game service, and the stored game management policy, and the processor is configured to determine an amount of service use corresponding to the location while generating the event, and, when the amount of service use exceeds a reference value, to change at least a portion of the game management policy.

### CROSS-REFERENCE TO RELATED APPLICATION AND CLAIM OF PRIORITY

This application is related to and claims priority to Korean Application No. 10-2017-0002229 filed on Jan. 6, 2017, the contents of which are incorporated herein by reference.

### TECHNICAL FIELD

Various embodiments of the present disclosure relate to an electronic device which provides a game service using a location-based service, and an operating method thereof.

### BACKGROUND

Electronic devices multiply performing one or more functions are increasingly used in recent years. Electronic devices are able to provide various data transfer services and various additional services, in addition to a voice communication service. For example, electronic devices are able to download game contents and provide online or offline game services.

Furthermore, electronic devices are able to provide game services combining location-based services and augmented reality technology (for example, augmented reality game services).

### SUMMARY

It is a primary object to extend and improve the functionality of an electronic device, including an electronic device which may provide an augmented reality game service having the real world (for example, the real world that a user can view with user's eyes) as a background. Accordingly, some electronic devices, may output an event generated according to a defined game policy by superimposing it on a view of the real world corresponding to a user's line of sight. For example, the event may be generated when the electronic device enters a specific location at a specific time. However, certain augmented reality games are games in which the electronic device passively receives the event generated by the defined game policy without regard to the context or location of the real world environment in which the device is situation, thereby limiting the game's interest to the user.

To address the above-discussed deficiencies, it is a primary object to provide at least the advantages described below. Accordingly, certain embodiments of the present disclosure provide an electronic device for providing a game service and a method thereof, which change an event processing method based on a geographical location of a client.

According to certain aspects of the present disclosure, there is an electronic device for providing a game service and a method thereof, which change an event processing method based on another client positioned on the periphery of a client.

According to certain embodiments of the present disclosure, there is provided an electronic device which includes a communication unit configured to communicate with at least one client, a memory configured to store a game management policy; and a processor configured to generate an event based on a location of the at least one client using a game service, and the stored game management policy, wherein the processor is configured to determine an amount of service use corresponding to the location while generating the event, and, when the amount of service use exceeds a reference value, to change at least a portion of the game management policy.

According to certain embodiments of the present disclosure, there is provided an operating method of an electronic device, the method including: forming communication with at least one client; generating an event based on a location of the at least one client and a game management policy which is stored in the electronic device; and, while generating the event, determining an amount of service use corresponding to the location, and, when the amount of service use exceeds a reference value, changing at least a portion of the game management policy.

According to certain embodiments of the present disclosure, there is provided a computer-readable recording medium which stores a program, which when executed by a processor performs the steps of: communicating with at least one client; generating an event based on a location of the at least one client and a game management policy which is stored in the electronic device; and, while generating the event, determining an amount of service use corresponding to the location, and, when the amount of service use exceeds a reference value, changing at least a portion of the game management policy.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an electronic device in a network environment according to various embodiments;

FIG. 2 illustrates, in block diagram format, an electronic device according to various embodiments;

FIG. 3 illustrates, in block diagram format, a program module according to various embodiments;

FIGS. 4A and 4B illustrate aspects of the configuration of a processor according to various embodiments of the present disclosure;

FIG. 5 illustrates, in flowchart format, operations of a method for providing a service using operation of an electronic device according to various embodiments of the present disclosure;

FIG. 6 illustrates, in flowchart format, operations of a service providing operation of an electronic device according to various embodiments of the present disclosure;

FIG. 7 illustrates, in flowchart format, an event processing operation of an electronic device according to various embodiments of the present disclosure;

FIGS. 8A and 8B illustrate aspects of an example of the event processing operation according to various embodiments of the present disclosure;

FIG. 9 illustrates, in flowchart format, an item recommending operation of an electronic device according to various embodiments of the present disclosure;

FIG. 10 illustrates, in flowchart format, an event processing operation of an electronic device according to various embodiments of the present disclosure;

FIGS. 11A and 11B illustrate aspects of an example of the event processing operation according to various embodiments of the present disclosure;

FIG. 12 illustrate, in flowchart format, an event processing operation of an electronic device according to various embodiments of the present disclosure;

FIGS. 13A and 13B illustrate aspects of an example of an event processing operation according to various embodiments of the present disclosure;

FIG. 14 illustrates, in flowchart format, a trade information determining operation of an electronic device according to various embodiments of the present disclosure; and

FIG. 15 illustrates aspects of an example of the trade information determining operation according to various embodiments of the present disclosure.

### DETAILED DESCRIPTION

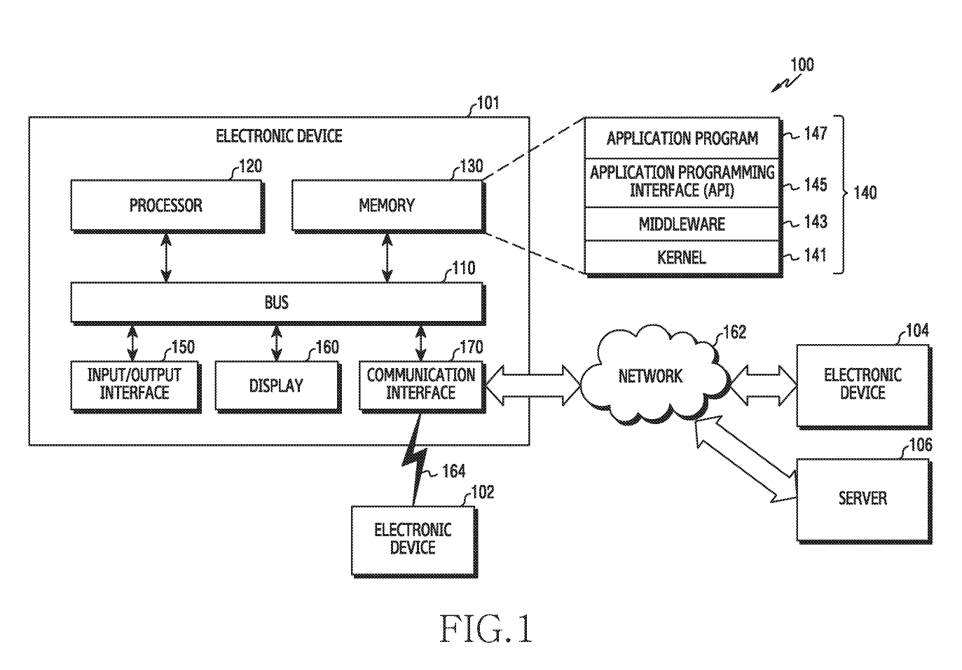

FIGS. 1 through 15, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, various embodiments of the present disclosure will be described with reference to the accompanying drawings. However, it should be understood that there is no intent to limit the present disclosure to the particular forms disclosed herein; rather, the present disclosure should be construed to cover various modifications, equivalents, and/or alternatives of embodiments of the present disclosure. In describing the drawings, similar reference numerals may be used to designate similar constituent elements.

As used herein, the expression “have”, “may have”, “include”, or “may include” refers to the existence of a corresponding feature (e.g., numeral, function, operation, or constituent element such as component), and does not exclude one or more additional features.

In the present disclosure, the expression “A or B”, “at least one of A or/and B”, or “one or more of A or/and B” may include all possible combinations of the items listed. For example, the expression “A or B”, “at least one of A and B”, or “at least one of A or B” refers to all of (1) including at least one A, (2) including at least one B, or (3) including all of at least one A and at least one B.

The expression “a first” “a second”, “the first”, or “the second” used in various embodiments of the present disclosure may modify various components regardless of the order and/or the importance but does not limit the corresponding components. For example, a first user device and a second user device indicate different user devices although both of them are user devices. For example, a first element may be termed a second element, and similarly, a second element may be termed a first element without departing from the scope of the present disclosure.

It should be understood that when an element (e.g., first element) is referred to as being (operatively or communicatively) “connected,” or “coupled,” to another element (e.g., second element), it may be directly connected or coupled directly to the other element or any other element (e.g., third element) may be interposer between them. In contrast, it may be understood that when an element (e.g., first element) is referred to as being “directly connected,” or “directly coupled” to another element (second element), there are no element (e.g., third element) interposed between them.

The expression “configured to” used in the present disclosure may be exchanged with, for example, “suitable for”, “having the capacity to”, “designed to”, “adapted to”, “made to”, or “capable of” according to the situation. The term “configured to” may not necessarily imply “specifically designed to” in hardware. Alternatively, in some situations, the expression “device configured to” may mean that the device, together with other devices or components, “is able to”. For example, the phrase “processor adapted (or configured) to perform A, B, and C” may mean a dedicated processor (e.g. embedded processor) for performing the corresponding operations or a generic-purpose processor (e.g., central processing unit (CPU) or application processor (AP)) that can perform the corresponding operations by executing one or more software programs stored in a memory device.

The terms used in the present disclosure are only used to describe specific embodiments, and are not intended to limit the present disclosure. As used herein, singular forms may include plural forms as well unless the context clearly indicates otherwise. Unless defined otherwise, all terms used herein, including technical and scientific terms, have the same meaning as those commonly understood by a person skilled in the art to which the present disclosure pertains. Such terms as those defined in a generally used dictionary may be interpreted to have the meanings equal to the contextual meanings in the relevant field of art, and are not to be interpreted to have ideal or excessively formal meanings unless clearly defined in the present disclosure. In some cases, even the term defined in the present disclosure should not be interpreted to exclude embodiments of the present disclosure.

An electronic device according to various embodiments of the present disclosure may include at least one of, for example, a smart phone, a tablet Personal Computer (PC), a mobile phone, a video phone, an electronic book reader (e-book reader), a desktop PC, a laptop PC, a netbook computer, a workstation, a server, a Personal Digital Assistant (PDA), a Portable Multimedia Player (PMP), a MPEG-1 audio layer-3 (MP3) player, a mobile medical device, a camera, and a wearable device. According to various embodiments, the wearable device may include at least one of an accessory type (e.g., a watch, a ring, a bracelet, an anklet, a necklace, a glasses, a contact lens, or a Head-Mounted Device (HMD)), a fabric or clothing integrated type (e.g., an electronic clothing), a body-mounted type (e.g., a skin pad, or tattoo), and a bio-implantable type (e.g., an implantable circuit).

According to some embodiments, the electronic device may be a home appliance. The home appliance may include at least one of, for example, a television, a Digital Video Disk (DVD) player, an audio, a refrigerator, an air conditioner, a vacuum cleaner, an oven, a microwave oven, a washing machine, an air cleaner, a set-top box, a home automation control panel, a security control panel, a TV box (e.g., Samsung HomeSync®, Apple TV®, or Google TV®), a game console (e.g., Xbox® and PlayStation®), an electronic dictionary, an electronic key, a camcorder, and an electronic photo frame.

According to another embodiment, the electronic device may include at least one of various medical devices (e.g., various portable medical measuring devices (a blood glucose monitoring device, a heart rate monitoring device, a blood pressure measuring device, a body temperature measuring device, etc.), a Magnetic Resonance Angiography (MRA), a Magnetic Resonance Imaging (MRI), a Computed Tomography (CT) machine, and an ultrasonic machine), a navigation device, a Global Positioning System (GPS) receiver, an Event Data Recorder (EDR), a Flight Data Recorder (FDR), a Vehicle Infotainment Devices, an electronic devices for a ship (e.g., a navigation device for a ship, and a gyro-compass), avionics, security devices, an automotive head unit, a robot for home or industry, an automatic teller's machine (ATM) in banks, point of sales (POS) in a shop, or internet device of things (e.g., a light bulb, various sensors, electric or gas meter, a sprinkler device, a fire alarm, a thermostat, a streetlamp, a toaster, a sporting goods, a hot water tank, a heater, a boiler, etc.).

According to some embodiments, the electronic device may include at least one of a part of furniture or a building/structure, an electronic board, an electronic signature receiving device, a projector, and various kinds of measuring instruments (e.g., a water meter, an electric meter, a gas meter, and a radio wave meter). The electronic device according to various embodiments of the present disclosure may be a combination of one or more of the aforementioned various devices. The electronic device according to some embodiments of the present disclosure may be a flexible device. Further, the electronic device according to embodiments of the present disclosure is not limited to the aforementioned devices, and may include a new electronic device according to the development of technology.

Hereinafter, an electronic device according to various embodiments will be described with reference to the accompanying drawings. As used herein, the term “user” may indicate a person who uses an electronic device or a device (e.g., an artificial intelligence electronic device) that uses an electronic device.

FIG. 1 illustrates a network environment including an electronic device according to various embodiments of the present disclosure.

An electronic device 101 within a network environment, according to various embodiments, will be described with reference to FIG. 1. The electronic device 101 may include a bus 110, a processor 120, a memory 130, an input/output interface 150, a display 160, and a communication interface 170. According to an embodiment of the present disclosure, the electronic device 101 may omit at least one of the above components or may further include other components.

The bus 110 may include, for example, a circuit which interconnects the components 110 to 170 and delivers a communication (e.g., a control message and/or data) between the components 110 to 170.

The processor 120 may include one or more of a Central Processing Unit (CPU), an Application Processor (AP), and a Communication Processor (CP). The processor 120 may carry out, for example, calculation or data processing relating to control and/or communication of at least one other component of the electronic device 101.

The memory 130 may include a volatile memory and/or a non-volatile memory. The memory 130 may store, for example, commands or data relevant to at least one other component of the electronic device 101. According to an embodiment of the present disclosure, the memory 130 may store software and/or a program 140. The program 140 may include, for example, a kernel 141, middleware 143, an Application Programming Interface (API) 145, and/or application programs (or “applications”) 147. At least some of the kernel 141, the middleware 143, and the API 145 may be referred to as an Operating System (OS).

The kernel 141 may control or manage system resources (e.g., the bus 110, the processor 120, or the memory 130) used for performing an operation or function implemented in the other programs (e.g., the middleware 143, the API 145, or the application programs 147). Furthermore, the kernel 141 may provide an interface through which the middleware 143, the API 145, or the application programs 147 may access the individual components of the electronic device 101 to control or manage the system resources.

The middleware 143, for example, may serve as an intermediary for allowing the API 145 or the application programs 147 to communicate with the kernel 141 to exchange data.

Also, the middleware 143 may process one or more task requests received from the application programs 147 according to priorities thereof. For example, the middleware 143 may assign priorities for using the system resources (e.g., the bus 110, the processor 120, the memory 130, or the like) of the electronic device 101, to at least one of the application programs 147. For example, the middleware 143 may perform scheduling or loading balancing on the one or more task requests by processing the one or more task requests according to the priorities assigned thereto.

The API 145 is, according to certain embodiments, an interface through which the applications 147 control functions provided from the kernel 141 or the middleware 143, and may include, for example, at least one interface or function (e.g., instruction) for file control, window control, image processing, character control, and the like.

The input/output interface 150, for example, may function as an interface that may transfer commands or data input from a user or another external device to the other element(s) of the electronic device 101. Furthermore, the input/output interface 150 may output the commands or data received from the other element(s) of the electronic device 101 to the user or another external device.

Examples of the display 160 may include a Liquid Crystal Display (LCD), a Light-Emitting Diode (LED) display, an Organic Light-Emitting Diode (OLED) display, a MicroElectroMechanical Systems (MEMS) display, or an electronic paper display. The display 160 may display, for example, various types of contents (e.g., text, images, videos, icons, or symbols) to users. The display 160 may include a touch screen, and may receive, for example, a touch, gesture, proximity, or hovering input using an electronic pen or a user's body part.

The communication interface 170 may establish communications, for example, between the electronic device 101 and an external device (e.g., a first external electronic device 102, a second external electronic device 104, or a server 106). For example, the communication interface 170 may be connected to a network 162 through wireless or wired communication, and may communicate with an external device (e.g., the second external electronic device 104 or the server 106). The wireless communication may use at least one of, for example, Long Term Evolution (LTE), LTE-Advance (LTE-A), Code Division Multiple Access (CDMA), Wideband CDMA (WCDMA), Universal Mobile Telecommunications System (UMTS), Wireless Broadband (WiBro), or Global System for Mobile Communications (GSM), as a cellular communication protocol. In addition, the wireless communication may include, for example, short range communication 164. The short-range communication 164 may include at least one of, for example, Wi-Fi, Bluetooth, Near Field Communication (NFC), and Global Navigation Satellite System (GNSS). GNSS may include, for example, at least one of global positioning system (GPS), global navigation satellite system (Glonass), Beidou Navigation satellite system (Beidou) or Galileo, and the European global satellite-based navigation system, based on a location, a bandwidth, or the like. Hereinafter, in the present disclosure, the “GPS” may be interchangeably used with the “GNSS”. The wired communication may include, for example, at least one of a Universal Serial Bus (USB), a High Definition Multimedia Interface (HDMI), Recommended Standard 232 (RS-232), or a Plain Old Telephone Service (POTS). The network 162 may include at least one of a telecommunication network such as a computer network (e.g., a LAN or a WAN), the Internet, or a telephone network.

Each of the first and second external electronic devices 102 and 104 may be of the same or different type as electronic device 101. According to an embodiment of the present disclosure, the server 106 may include a group of one or more servers. According to various embodiments of the present disclosure, all or some of the operations performed in the electronic device 101 may be executed in another electronic device or a plurality of electronic devices (e.g., the electronic devices 102 and 104 or the server 106). According to at least one embodiment of the present disclosure, when the electronic device 101 has to perform some functions or services automatically or in response to a request, the electronic device 101 may request another device (e.g., the electronic device 102 or 104 or the server 106) to execute at least some functions relating thereto instead of or in addition to autonomously performing the functions or services. Another electronic device (e.g., the electronic device 102 or 104, or the server 106) may execute the requested functions or the additional functions, and may deliver a result of the execution to the electronic device 101. The electronic device 101 may process the received result as it is or additionally, and may provide the requested functions or services. To this end, for example, cloud computing, distributed computing, or client-server computing technologies may be used.

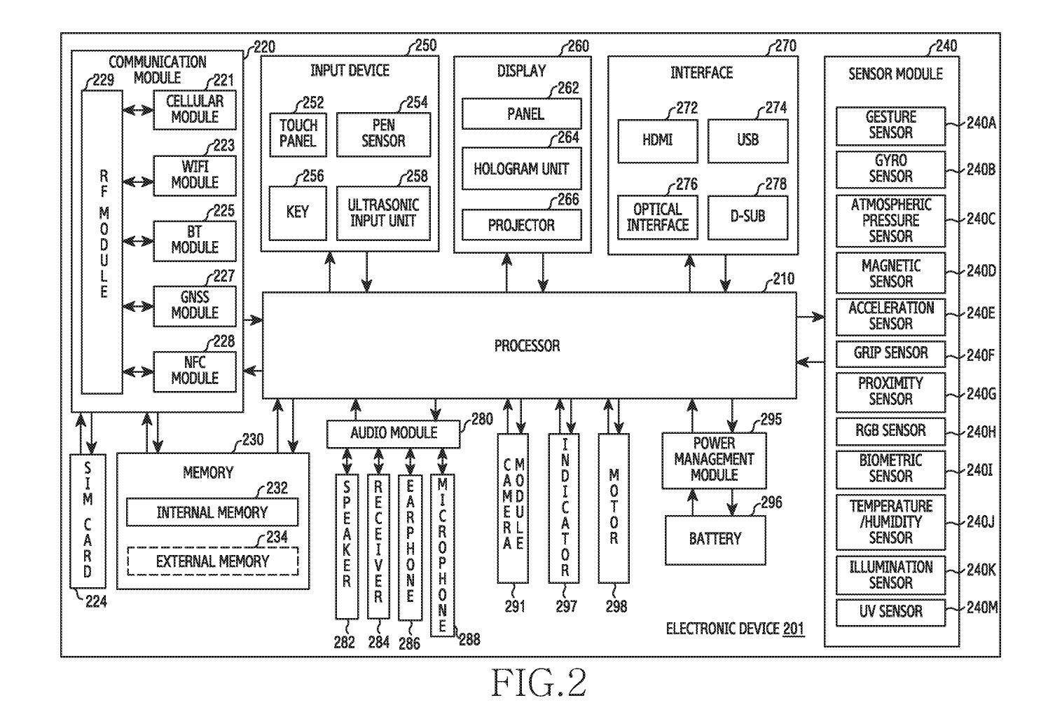

FIG. 2 illustrates, in block diagram format, an electronic device according to various embodiments of the present disclosure.

According to certain embodiments, electronic device 201 may include, for example, all or a part of the electronic device 101 shown in FIG. 1. The electronic device 201 may include one or more processors 210 (e.g., Application Processors (AP)), a communication module 220, a Subscriber Identification Module (SIM) 224, a memory 230, a sensor module 240, an input device 250, a display 260, an interface 270, an audio module 280, a camera module 291, a power management module 295, a battery 296, an indicator 297, and a motor 298.

The processor 210 may control a plurality of hardware or software components connected to the processor 210 by driving an operating system or an application program, and perform processing of various pieces of data and calculations. The processor 210 may be embodied as, for example, a System on Chip (SoC). According to an embodiment of the present disclosure, the processor 210 may further include a Graphic Processing Unit (GPU) and/or an image signal processor. The processor 210 may include at least some (for example, a cellular module 221) of the components illustrated in FIG. 2. The processor 210 may load, into a volatile memory, commands or data received from at least one (e.g., a non-volatile memory) of the other components and may process the loaded commands or data, and may store various data in a non-volatile memory.

The communication module 220 may, according to some embodiments, have a configuration equivalent or similar to that of the communication interface 170 of FIG. 1. The communication module 220 may include, for example, a cellular module 221, a Wi-Fi module 223, a BT module 225, a GNSS module 227 (e.g., a GPS module, a Glonass module, a Beidou module, or a Galileo module), an NFC module 228, and a Radio Frequency (RF) module 229.

The cellular module 221, for example, may provide a voice call, a video call, a text message service, or an Internet service through a communication network. According to some embodiments of the present disclosure, the cellular module 221 may distinguish and authenticate the electronic device 201 in a communication network using the subscriber identification module 224 (for example, the SIM card). According to an embodiment of the present disclosure, the cellular module 221 may perform at least some of the functions that the AP 210 may provide. According to an embodiment of the present disclosure, the cellular module 221 may include a communication processor (CP).

According to certain embodiments, each of the Wi-Fi module 223, the BT module 225, the GNSS module 227, and the NFC module 228 may include a processor for processing data transmitted/received through a corresponding module. According to at least one embodiment of the present disclosure, at least some (e.g., two or more) of the cellular module 221, the Wi-Fi module 223, the BT module 225, the GNSS module 227, and the NFC module 228 may be included in one Integrated Chip (IC) or IC package.

The RF module 229, for example, may transmit or receive a communication signal (e.g., an RF signal). The RF module 229 may include, for example, a transceiver, a Power Amplifier Module (PAM), a frequency filter, a Low Noise Amplifier (LNA), and an antenna. According to some embodiments of the present disclosure, at least one of the cellular module 221, the WIFI module 223, the BT module 225, the GNSS module 227, and the NFC module 228 may transmit/receive an RF signal through a separate RF module.

According to certain embodiments of this disclosure, subscriber identification module 224 may include, for example, a card including a subscriber identity module and/or an embedded SIM, and may contain unique identification information (e.g., an Integrated Circuit Card Identifier (ICCID)) or subscriber information (e.g., an International Mobile Subscriber Identity (IMSI)).

The memory 230 (e.g., the memory 130) may include, for example, an embedded memory 232 or an external memory 234. The embedded memory 232 may include at least one of a volatile memory (e.g., a Dynamic Random Access Memory (DRAM), a Static RAM (SRAM), a Synchronous Dynamic RAM (SDRAM), and the like) and a non-volatile memory (e.g., a One Time Programmable Read Only Memory (OTPROM), a Programmable ROM (PROM), an Erasable and Programmable ROM (EPROM), an Electrically Erasable and Programmable ROM (EEPROM), a mask ROM, a flash ROM, a flash memory (e.g., a NAND flash memory or a NOR flash memory), a hard disc drive, a Solid State Drive (SSD), and the like).

The external memory 234 may further include a flash drive, for example, a Compact Flash (CF), a Secure Digital (SD), a Micro Secure Digital (Micro-SD), a Mini Secure Digital (Mini-SD), an eXtreme Digital (xD), a MultiMediaCard (MMC), a memory stick, or the like. The external memory 234 may be functionally and/or physically connected to the electronic device 201 through various interfaces.

According to certain embodiments, sensor module 240, for example, may measure a physical quantity or detect an operation state of the electronic device 201, and may convert the measured or detected information into an electrical signal. The sensor module 240 may include, for example, at least one of a gesture sensor 240A, a gyro sensor 240B, an atmospheric pressure sensor (barometer) 240C, a magnetic sensor 240D, an acceleration sensor 240E, a grip sensor 240F, a proximity sensor 240G, a color sensor 240H (e.g., red, green, and blue (RGB) sensor), a biometric sensor (medical sensor) 2401, a temperature/humidity sensor 240J, an illuminance sensor 240K, and a Ultra Violet (UV) sensor 240M. Additionally or alternatively, the sensor module 240 may include, for example, an E-nose sensor, an electromyography (EMG) sensor, an electroencephalogram (EEG) sensor, an electrocardiogram (ECG) sensor, an Infrared (IR) sensor, an iris scan sensor, and/or a finger scan sensor. The sensor module 240 may further include a control circuit for controlling one or more sensors included therein. According to an embodiment of the present disclosure, the electronic device 201 may further include a processor configured to control the sensor module 240, as a part of the processor 210 or separately from the processor 210, and may control the sensor module 240 while the processor 210 is in a sleep state.

The input device 250 may include, for example, a touch panel 252, a (digital) pen sensor 254, a key 256, or an ultrasonic input device 258. The touch panel 252 may use, for example, at least one of a capacitive type, a resistive type, an infrared type, and an ultrasonic type. The touch panel 252 may further include a control circuit. The touch panel 252 may further include a tactile layer, and provide a tactile reaction to the user.

The (digital) pen sensor 254 may include, for example, a recognition sheet which is a part of the touch panel or is separated from the touch panel. The key 256 may include, for example, a physical button, an optical key or a keypad. The ultrasonic input device 258 may detect, through a microphone (e.g., the microphone 288), ultrasonic waves generated by an input tool, and identify data corresponding to the detected ultrasonic waves.

The display 260 (e.g., the display 160) may include a panel 262, a hologram device 264, or a projector 266. The panel 262 may include a configuration identical or similar to the display 160 illustrated in FIG. 1. The panel 262 may be implemented to be, for example, flexible, transparent, or wearable. The panel 262 may be embodied as a single module with the touch panel 252. The hologram device 264 may show a three dimensional (3D) image in the air by using an interference of light. The projector 266 may project light onto a screen to display an image. The screen may be located, for example, in the interior of or on the exterior of the electronic device 201. According to an embodiment of the present disclosure, the display 260 may further include a control circuit for controlling the panel 262, the hologram device 264, or the projector 266.

The interface 270 may include, for example, a High-Definition Multimedia Interface (HDMI) 272, a Universal Serial Bus (USB) 274, an optical interface 276, or a D-subminiature (D-sub) 278. The interface 270 may be included in, for example, the communication interface 170 illustrated in FIG. 1. Additionally or alternatively, the interface 270 may include, for example, a Mobile High-definition Link (MHL) interface, a Secure Digital (SD) card/Multi-Media Card (MMC) interface, or an Infrared Data Association (IrDA) standard interface.

The audio module 280, for example, may convert a sound to an electrical signal and vice versa. At least some components of the audio module 280 may be included in, for example, the input/output interface 150 illustrated in FIG. 1. The audio module 280 may process voice information input or output through, for example, a speaker 282, a receiver 284, earphones 286, or the microphone 288.

The camera module 291 is, for example, a device which may photograph a still image and a video. According to certain embodiments of the present disclosure, the camera module 291 may include one or more image sensors (e.g., a front sensor or a back sensor), a lens, an Image Signal Processor (ISP) or a flash (e.g., LED or xenon lamp).

The power management module 295 may manage, for example, power of the electronic device 201. According to an embodiment of the present disclosure, the power management module 295 may include a Power Management Integrated Circuit (PMIC), a charger Integrated Circuit (IC), or a battery or fuel gauge. The PMIC may use a wired and/or wireless charging method. Examples of the wireless charging method may include, for example, a magnetic resonance method, a magnetic induction method, an electromagnetic wave method, and the like. Additional circuits (e.g., a coil loop, a resonance circuit, a rectifier, etc.) for wireless charging may be further included. The battery gauge may measure, for example, a residual quantity of the battery 296, and a voltage, a current, or a temperature while charging. The battery 296 may include, for example, a rechargeable battery and/or a solar battery.

The indicator 297 may display a particular state (e.g., a booting state, a message state, a charging state, or the like) of the electronic device 201 or a part (e.g., the processor 210) of the electronic device 201. The motor 298 may convert an electrical signal into a mechanical vibration, and may generate a vibration, a haptic effect, or the like. Although not illustrated, the electronic device 201 may include a processing device (e.g., a GPU) for supporting a mobile TV. The processing device for supporting a mobile TV may process, for example, media data according to a certain standard such as Digital Multimedia Broadcasting (DMB), Digital Video Broadcasting (DVB), or mediaFLO®.

Each of the above-described component elements of hardware according to the present disclosure may be configured with one or more components, and the names of the corresponding component elements may vary based on the type of electronic device. In various embodiments, the electronic device may include at least one of the above-described elements. Some of the above-described elements may be omitted from the electronic device, or the electronic device may further include additional elements. Also, some of the hardware components according to various embodiments may be combined into one entity, which may perform functions identical to those of the relevant components before the combination.

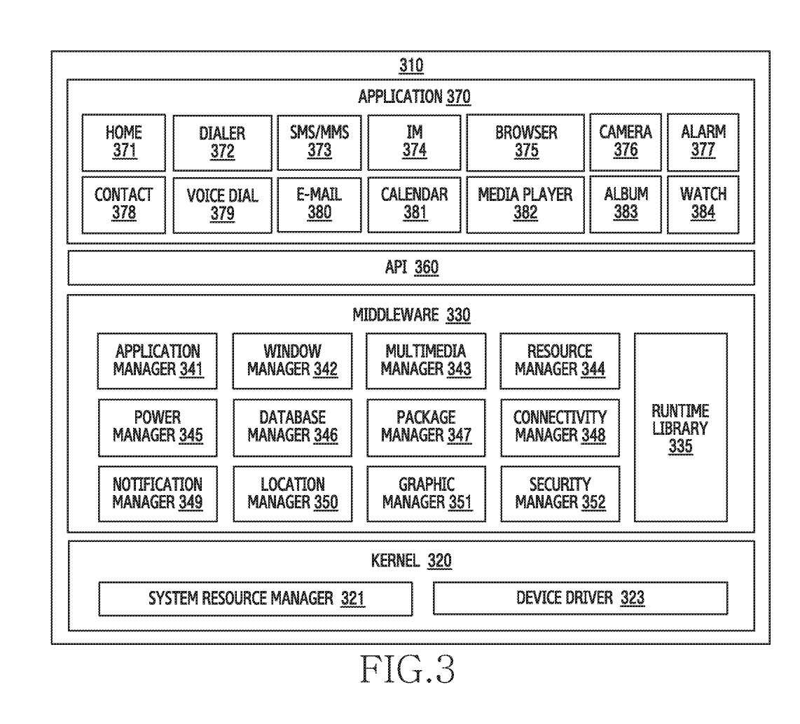

FIG. 3 illustrates, in block diagram format, a program module according to various embodiments of the present disclosure.

According to an embodiment of the present disclosure, the program module 310 (which, according to some embodiments may correspond to program 140 shown in FIG. 1) may include an Operating System (OS) for controlling resources related to the electronic device (e.g., the electronic device 101) and/or various applications (e.g., the application programs 147) executed in the operating system. The operating system may comprise, for example, Android®, iOS®, Windows®, Symbian®, Tizen®, Bada®, or the like.

The program module 310 may include a kernel 320, middleware 330, an API 360, and/or applications 370. In certain embodiments, at least some of the program module 310 may be preloaded on an electronic device, or may be downloaded from an external electronic device (e.g., the electronic device 102 or 104, or the server 106).

The kernel 320 (e.g., the kernel 141) may include, for example, a system resource manager 321 and/or a device driver 323. The system resource manager 321 may control, allocate, or collect system resources. According to some embodiments of the present disclosure, the system resource manager 321 may include a process management unit, a memory management unit, a file system management unit, and the like. The device driver 323 may include, for example, a display driver, a camera driver, a Bluetooth® driver, a shared memory driver, a USB driver, a keypad driver, a Wi-Fi driver, an audio driver, or an Inter-Process Communication (IPC) driver.

For example, the middleware 330 may provide a function required in common by the applications 370, or may provide various functions to the applications 370 through the API 360 so as to enable the applications 370 to efficiently use the limited system resources in the electronic device. According to an embodiment of the present disclosure, the middleware 330 (e.g., the middleware 143) may include at least one of a run time library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, and a security manager 352.

In some embodiments according to the present disclosure, runtime library 335 may include a library module which a compiler uses in order to add a new function through a programming language while an application 370 is being executed. The runtime library 335 may perform input/output management, memory management, the functionality for an arithmetic function, or the like.

The application manager 341 may according to embodiments, manage, for example, a life cycle of at least one of the applications 370. The window manager 342 may manage Graphical User Interface (GUI) resources used by a screen. The multimedia manager 343 may recognize a format required for reproduction of various media files, and may perform encoding or decoding of a media file by using a codec suitable for the corresponding format. The resource manager 344 may manage resources of a source code, a memory, and a storage space of at least one of the applications 370.

According to certain embodiments, power manager 345 may operate together with, for example, a Basic Input/Output System (BIOS) or the like to manage a battery or power source and may provide power information or the like required for the operations of the electronic device. The database manager 346 may generate, search for, and/or change a database to be used by at least one of the applications 370. The package manager 347 may manage installation or an update of an application distributed in a form of a package file.

For example, the connectivity manager 348 may manage wireless connectivity such as Wi-Fi or Bluetooth. The notification manager 349 may display or notify of an event such as an arrival message, promise, proximity notification, and the like in such a way that does not disturb a user. The location manager 350 may manage location information of an electronic device. The graphic manager 351 may manage a graphic effect which will be provided to a user, or a user interface related to the graphic effect. The security manager 352 may provide all security functions required for system security, user authentication, or the like. According to an embodiment of the present disclosure, when the electronic device (e.g., the electronic device 101) provides a telephone call function, the middleware 330 may further include a telephony manager for managing a voice call function or a video call function of the electronic device.

In some embodiments of this disclosure, middleware 330 may include a middleware module that forms a combination of various functions of the above-described components. The middleware 330 may provide a module specialized for each type of OS in order to provide a differentiated function. Further, the middleware 330 may dynamically remove some of the existing components or add new components.

The API 360 (which, according to certain embodiments, may be similar to API 145 in FIG. 1) comprises, for example, a set of API programming functions, and may be provided with a different configuration according to an OS. For example, in the case of Android or iOS, one API set may be provided for each platform. In the case of Tizen, two or more API sets may be provided for each platform.

The applications 370 (e.g., the application programs 147) may include, for example, one or more applications which provide functions such as a home 371, a dialer 372, an SMS/MMS 373, an Instant Message (IM) 374, a browser 375, a camera 376, an alarm 377, contacts 378, a voice dial 379, an email 380, a calendar 381, a media player 382, an album 383, a clock 384, health care (e.g., measuring exercise quantity or blood sugar), or environment information (e.g., providing atmospheric pressure, humidity, or temperature information).

According to certain embodiments of the present disclosure, applications 370 may include an application (hereinafter, referred to as an “information exchange application” for convenience of description) which supports exchanging information between the electronic device (e.g., the electronic device 101) and an external electronic device (e.g., the electronic device 102 or 104). The information exchange application may include, for example, a notification relay application for transferring specific information to an external electronic device or a device management application for managing an external electronic device.

For example, the notification relay application may, according to embodiments, include a function of transferring, to the external electronic device (e.g., the electronic device 102 or 104), notification information generated from other applications of the electronic device 101 (e.g., an SMS/MMS application, an e-mail application, a health management application, or an environmental information application). Further, the notification relay application may receive notification information from, for example, an external electronic device and provide the received notification information to a user.

In some embodiments, the device management application may manage (e.g., install, delete, or update), for example, at least one function of an external electronic device (e.g., the electronic device 102 or 104) communicating with the electronic device (e.g., a function of turning on/off the external electronic device itself (or some components) or a function of adjusting the brightness (or a resolution) of the display), applications operating in the external electronic device, and services provided by the external electronic device (e.g., a call service or a message service).

According to some embodiments of the present disclosure, the applications 370 may include applications (e.g., a health care application of a mobile medical appliance or the like) designated according to an external electronic device (e.g., attributes of the electronic device 102 or 104). According to an embodiment of the present disclosure, the applications 370 may include an application received from an external electronic device (e.g., the server 106, or the electronic device 102 or 104). According to at least one embodiment of the present disclosure, the applications 370 may include a preloaded application or a third party application that may be downloaded from a server. The names of the components of the program module 310 of the illustrated embodiment of the present disclosure may change according to various embodiments, depending on for example, the type of operating system.

According to various embodiments, at least a part of the programming module 310 may be implemented in software, firmware, hardware, or a combination of two or more thereof. At least some of the program module 310 may be implemented (e.g., executed) by, for example, the processor (e.g., the processor 1410). At least some of the program module 310 may include, for example, a module, a program, a routine, a set of instructions, and/or a process for performing one or more functions.

The term “module” as used herein may, for example, encompass a unit including one of hardware, software, and firmware or a combination of two or more of them. The term “module” may be interchangeably used with, for example, the terms “unit”, “logic”, “logical block”, “component”, or “circuit”. As used herein, the term “module” may encompass a unit of an integrated component element or a part thereof. According to embodiments, a “module” may be a unit for performing one or more functions or a part thereof. The “module” may be mechanically or electronically implemented. For example, the “module” according to the present disclosure may include at least one of an Application-Specific Integrated Circuit (ASIC) chip, a Field-Programmable Gate Arrays (FPGA), and a programmable-logic device for performing operations which has been known or are to be developed hereinafter.

According to various embodiments, at least some of the devices (for example, modules or functions thereof) or the method (for example, operations) according to the present disclosure may be implemented by a command stored in a computer-readable storage medium in a programming module form. The instruction, when executed by a processor (e.g., the processor 120), may cause the one or more processors to execute the function corresponding to the instruction. The computer-readable storage medium may be, for example, the memory 130.

The computer readable recoding medium may include a hard disk, a floppy disk, magnetic media (e.g., a magnetic tape), optical media (e.g., a Compact Disc Read Only Memory (CD-ROM) and a Digital Versatile Disc (DVD)), magneto-optical media (e.g., a floptical disk), a hardware device (e.g., a Read Only Memory (ROM), a Random Access Memory (RAM), a flash memory), and the like. In addition, the program instructions may include high level language code, which can be executed in a computer by using an interpreter, as well as compiled machine code. The aforementioned hardware device may be configured to operate as one or more software modules in order to perform the operation of the present disclosure, and vice versa.

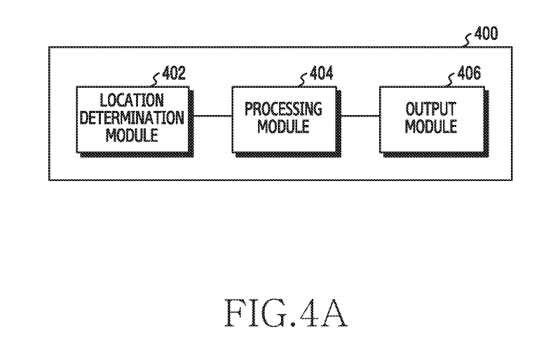

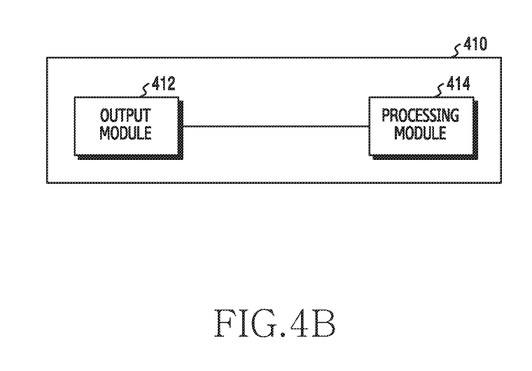

FIGS. 4A and 4B illustrate aspects of a configuration of a processor according to various embodiments of the present disclosure. According to one embodiment, the processor may include all or part of the electronic device 101 or the electronic device 201.

Referring to FIG. 4A, the processor 400 may, in some embodiments, be a processor of a client which accesses a service server (for example, a game service server 106) and uses a service (for example, a game service). Furthermore, the processor 400 may include a location determination module 402, a processing module 404, and an output module 406.

According to at least one embodiment of this disclosure, the location determination module 402 may periodically or continuously determine a location (for example, a current location, a moving location, or the like) of an electronic device which uses a game service (for example, an augmented reality or location-based game service). For example, the location determination module 402 may determine a geographical location of the electronic device using the game service by processing a signal received from a GPS satellite. In some embodiments, the location determination module 402 may determine the location of the electronic device and may provide the same to the processing module 404.

According to some embodiments, the processing module 404 may access the service server and may use the game service. For example, the processing module 404 may execute a game-related program stored in the electronic device, and may access the service server. For example, the processing module 404 may request an access by transmitting predetermined authentication information (for example, a user ID and a password) to the service server.

According to certain embodiments, the processing module 404 may periodically or continuously receive information related to the game service through the service server in response to the electronic device accessing the service server. For example, the processing module 404 may receive information related to an object (for example, a character) outputted on a game, an owned item related to the object, or the like.

According to at least one embodiment, the processing module 404 may proceed with the game service through the service server in response to the information related to the game service being received. For example, the processing module 404 may provide the information received from the game service server to the output module 406 to output a game screen.

According to certain embodiments, the processing module 404 may control at least one object outputted to a screen during the game. For example, the processing module 404 may move the object displayed on the screen or may do an action that the user desires to do through the object. For example, the processing module 404 may control the object based on a touch input, a key input, a voice input, a motion of the electronic device, or the like.

According to some embodiments, the processing module 404 may transmit the geographical location of the electronic device which is provided from the location determination module 402 to the accessed service server during the game.

According to certain embodiments, the processing module 404 may receive an event from the service server during the game. For example, the processing module 404 may receive an event corresponding to the geographical location of the electronic device. For example, the event may be at least one of the functions executed on the game, and may include, without limitation, at least one of an item acquisition event, an item trade event, or an item use event. Furthermore, the processing module 404 may transmit data (for example, user input data) for processing the received event to the service server. For example, the processing module 404 may transmit, to the service server, information related to a type of a trade item, a number of trade items, and a price of a trade item, in order to process the item trade event.

According to certain embodiments, the output module 406 may output an execution screen of the game service. For example, the output module 406 may output a screen for receiving input of predetermined authentication information in response to the game service being executed. Furthermore, the output module 406 may output a game screen which outputs as images, the information (for example, information related to the game and/or an event received from the service server) received from the service server, in response to the electronic device accessing the service server. For example, the output module 406 may output the imaged game screen by superimposing at least a portion of the imaged game screen with a view of the real world corresponding to a user's line of sight.

Referring to FIG. 4B, according to certain embodiments, processor 410 may be a processor of a service server (for example, the game service server 106) providing a service (for example, a game service). Furthermore, the processor 410 may include a determination module 412 and a processing module 414.

According to certain embodiments of this disclosure, the determination module 412 may determine a service location of at least one client. For example, the determination module 412 may determine a geographical location of the client which uses the game service. For example, the determination module 412 may determine the service location by receiving location information from the at least one client.

According to some embodiments, the determination module 412 may calculate an amount of service use corresponding to the service location in response to the service location being determined. For example, the determination module 412 may identify other clients which use the game service within a predetermined distance from the location of the client. For example, the amount of service use may correspond to the number of concurrent users accessing the service location.

According to some embodiments of the present disclosure, the processing module 414 may provide the game service to the at least one client. For example, the processing module 414 may receive predetermined authentication information received from the client which requests use of the game service, and may provide the game service to the client which is authorized to access the game service. For example, the processing module 414 may periodically or continuously transmit information related to the game to the client which is authorized to access the game service.

According to certain embodiments of this disclosure, the processing module 414 may generate an event based on the service location on the client and a pre-defined game management policy while providing the game service. The event may be at least one function executed on the game, and may include at least one of an item acquisition event, an item trade event, or an item use event.

By way of non-limiting example, when the client enters an item generation region designated in the game, the processing module 414 may determine that the item acquisition event has been generated. In this illustrative case, the processing module 414 may generate an item which is determined based on the pre-defined game management policy (for example, an item generation policy) at the current location of the client.

In another strictly illustrative example of an embodiment according to the present disclosure, when the client enters a designated trade region, the processing module 414 may determine that the item trade event has been generated. In this case, the processing module 414 may extract information on a trade item corresponding to the location of the client from a database in which items traded in each region are defined. Furthermore, the processing module 414 may, in certain embodiments, process the item trade event using item trade information (for example, a price of a trade item, a number of trade items, or the like) which is determined based on the pre-defined game management policy (for example, a trade policy).

According to some embodiments, when an event is generated, the processing module 414 may change the game management policy based on the amount of service use corresponding to the service location.

For example, when an amount of service use corresponding to a location (for example, a client's current location) in which the item acquisition event is detected is greater than or equal to a reference value, the processing module 414 may change at least a portion of the pre-defined game management policy, and may process to determine an item to be generated at the location of the client based on the changed policy. For example, the processing module 414 may generate an item having a higher grade (or lower grade) than when the amount of service use is less than the reference value.

In another example, when an amount of service use corresponding to a location (for example, a client's current location) in which the item trade event is detected is greater than or equal to a reference value, the processing module 414 may change at least a portion of the pre-defined game management policy, and may process to determine item trade information based on the changed policy. For example, the processing module 414 may process the item to be traded at a higher price (or a lower price) than when the amount of service use is less than the reference value.

Furthermore, the processing module 414 may change at least a portion of the game management policy according to whether a new item is added while processing the item trade event. For example, when a new item is designated as a trade target in a region that the client enters, the processing module 414 may change at least a portion of the game management policy and drop (or increase) the price of an existing item which has been traded in the region that the client enters.

According to some embodiments, while processing the item trade event, the processing module 414 may change at least a portion of the game management policy based on a distance between an item trading region and a place of origin of an item which is traded through the game. For example, the place of origin may be a country or a region. For example, when the distance between the region which the client enters and the place of origin of the traded item is greater than or equal to a predetermined value, the processing module 414 may change at least a portion of the game management policy and may raise (or reduce) the price of the item which is traded in the region that the client enters.

In some embodiments, while processing the item trade event, the processing module 414 may change at least a portion of the game management policy based on a region in which the game service is used. For example, the processing module 414 may differently manage the game management policy when the client accesses the service server in a first country or a first region, and the game management policy when the client accesses the service server in a second country or a second region. For example, the processing module 414 may raise (or reduce) the price of an item which is traded by the client accessing the service server in the first country or the first region, in comparison to the price of the same item that is traded by the client accessing the service server in the second country or the second region.

In another illustrative example, when the client enters a pre-designated fighting zone, the processing module 414 may determine that the item use event is generated. In this case, the processing module 414 may recommend an appropriate item for the client to use based on an amount of service use in the zone that the client enters. For example, in response to it being determined that the amount of service use is greater than or equal to a reference value, the processing module 414 may determine an appropriate level of an item corresponding to the amount of service use, and may select and recommend an item corresponding to the determined appropriate level from among the items that the client has.

According to various embodiments, an electronic device may include: a communication unit configured to communicate with at least one client; a memory configured to store a game management policy; and a processor configured to generate an event based on a location of the at least one client using a game service, and the stored game management policy. According to one embodiment, the processor may be configured to determine an amount of service use corresponding to the location while generating the event, and, when the amount of service use exceeds a reference value, to change at least a portion of the game management policy.

According to various embodiments, the processor may be configured to determine a geographical location where the at least one client is positioned.

According to various embodiments, the processor may be configured to change the game management policy and to change trade information on an item which is traded on the game service.

According to various embodiments, the processor may be configured to change the game management policy based on an item which is newly added in the location of the at least one client.

According to various embodiments, the trade information of the item may include at least one of a type of a trade item, a number of trade items, and a price of a trade item.

According to various embodiments, the processor may be configured to change the game management policy and to change an attribute of an item to be acquired by the at least one client.

According to various embodiments, the processor may be configured to recommend an item to be used by the at least one client based on the amount of service use corresponding to the location.

According to various embodiments, the processor may be configured to acquire additional information on the at least one client, and to recommend an item to be used by the at least one client.

According to various embodiments, the processor may be configured to calculate the amount of service use based on a number of concurrent users accessing the location of the at least one client.

According to various embodiments, the electronic device may include a service server.

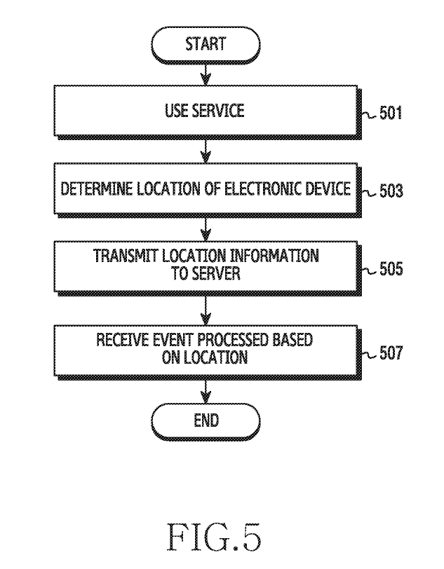

FIG. 5 illustrates, in flowchart format, a service using operation of an electronic device according to various embodiments of the present disclosure. According to at least one embodiment, the electronic device may be a client which accesses a service server (for example, the game service server 106) and uses a service (for example, a game service), and may be all or part of the electronic device 101 or the electronic device 201.

Referring to FIG. 5, the processor 400 may access a service server and use a game service in operation 501. According to one embodiment, the processor 400 may use the game service by requesting access to the service server. For example, the processor 400 may request the access by transmitting predetermined authentication information (for example, a user ID and a password) to the service server. Furthermore, in response to the electronic device accessing the service server, the processor 400 may receive information related to the game service (for example, an object (for example, a character) outputted on the game, an owned item related to the object, or the like) from the service server, and may output a game screen which images the received information. For example, the processor 400 may output the game screen by superimposing at least a portion of the imaged game screen on a view of the real world corresponding to a user's line of sight.

In operation 503, the processor 400 may, according to various embodiments, determine a location of the electronic device. According to one embodiment, the processor 400 may determine geographical information (for example, latitude, and longitude) of a region in which the electronic device is currently positioned. For example, the processor 400 may determine the location of the electronic device by receiving a GPS satellite signal from a GPS satellite. In another example, the processor 400 may receive location information of the electronic device from an external device.

In operation 505, the processor 400 may, according to some embodiments, transmit the determined location of the electronic device to the service server.

According to some embodiments, at operation 507, the processor 400 may receive an event corresponding to the location of the electronic device, and may output the event to the game screen. According to one embodiment, the event may be at least one function executed in the game, and may include at least one of an item acquisition event, an item trade event, and an item use event. For example, the processor 400 may acquire a new item that the electronic device does not have, or may update the item that the electronic device has (or stores) by receiving and processing the item acquisition event. As another non-limiting example, the processor 400 may sell an item which the electronic device has to a user or may buy an item that another user has by receiving and processing the item trade event.

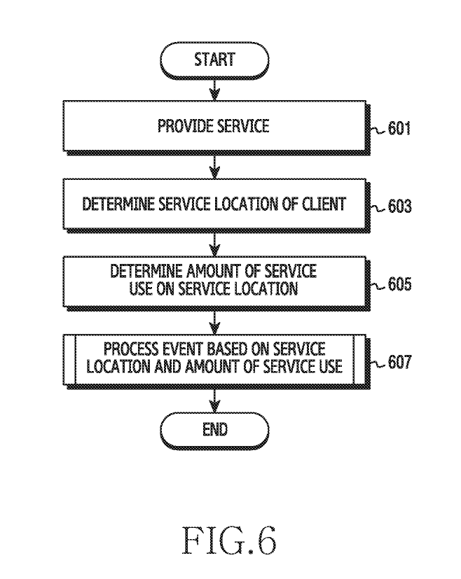

FIG. 6 illustrates, in flowchart format, a service providing operation of an electronic device according to various embodiments of the present disclosure. According to one embodiment, the electronic device may be a service sever (for example, the game service server 106) which provides a service (for example, a game service) to a client, and may include all or part of the electronic device 101 or the electronic device 201. Furthermore, the electronic device may store a variety of information related to a game in progress, such as game map information, a game management policy, game quest information, or the like.

Referring to FIG. 6, the processor 410 may, according to embodiments, provide a game service to clients in operation 601. According to one embodiment, the processor 410 may provide information related to the game service (for example, an object (for example, a character outputted to a game), an owned item related to the object, or the like) to at least one client which requests an access.

According to certain embodiments, at operation 603, the processor 410 may determine a service location on the at least one client using the service. According to one embodiment, the service location may include geographical information (for example, latitude, longitude) on the location of the client using the game service. For example, the processor 410 may receive location information from respective clients using the game service. In other embodiments, the processor 410 may distinguish a client which processes a pre-designated event, and may receive location information from the distinguished client. For example, the processor 410 may receive location information from a client which tries at least one event from among an event for trying to acquire an item, an event for trying to trade an item, and an event for trying to use an item.

According to certain embodiments, at operation 605, the processor 410 may determine an amount of service use corresponding to the service location. According to one embodiment, the processor 410 may identify other clients which use the game service within a predetermined distance from the service location of the client. For example, the processor 410 may determine the number of concurrent users accessing the service location as the amount of service use.

In some embodiments according to the present disclosure, at operation 607, the processor 410 may process an event based on the service location and the amount of service use. According to one embodiment, when it is determined that the amount of service use is less than a reference value, the processor 410 may process the event based on a pre-defined game management policy. In addition, when it is determined that the amount of service use is greater than or equal to the reference value, the processor 410 may change at least a portion of the pre-defined game management policy, and may process the event. For example, when it is determined that the amount of service use is greater than or equal to the reference value, the processor 410 may change at least one of a trade price of an item, a frequency of acquiring an item, a type of an acquired item, and a grade of an item.

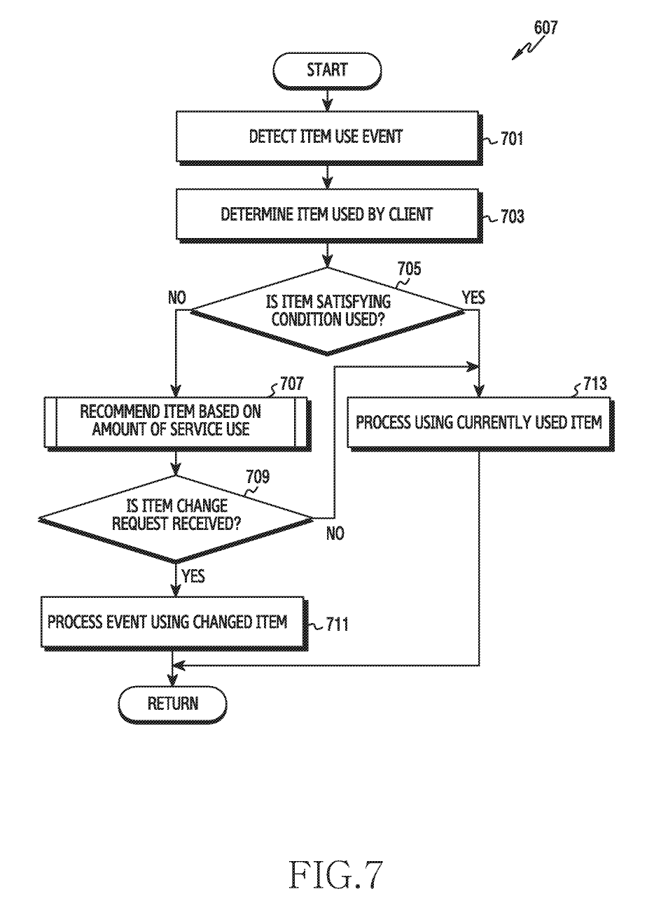

FIG. 7 illustrates, in flowchart format, an event processing operation of an electronic device according to various embodiments of the present disclosure.

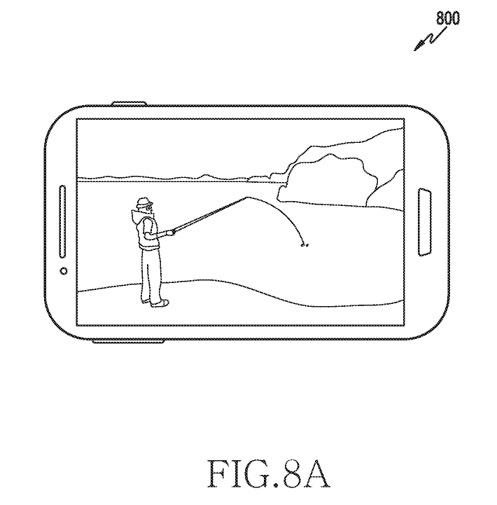

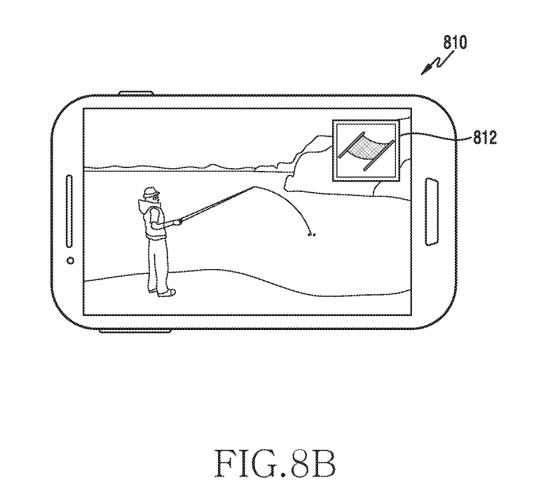

FIGS. 8A and 8B illustrate aspects of an example of the event processing operation according to various embodiments of the present disclosure. According to one embodiment, the event processing operation of the electronic device comprise an operation such as operation 607 described in FIG. 6.

Referring to FIG. 7, the processor 410 may, according to certain embodiments, detect an item use event in operation 701. According to one embodiment, the item use event may be an event in which a game (or a game service) is played using at least one of items that an object (for example, a character) controlled by the client has. For example, the processor 410 may detect that the item use event is generated in response to it being detected that the controlled object wears clothing or an accessory or carries a weapon.

According to certain embodiments, at operation 703, the processor 410 may determine an item which is being used by the client. According to one embodiment, the processor 410 may determine an item which is worn on the object to play the game from among the items that the client has.

According to some embodiments, at operation 705, the processor 410 may determine whether the item used by the client satisfies a condition. According to one embodiment, the processor 410 may determine an amount of service use corresponding to a service location of the client, and may determine whether the item satisfies the condition based on the amount of service use. For example, the processor 410 may determine a suitable level of an item corresponding to the amount of service use, and may compare it with the level of the item which is currently used by the client. For example, when the suitable level of the item is higher than the level of the item which is currently used by the client, the processor 410 may determine that the item used by the client does not satisfy the condition. On the other hand, when the suitable level of the item is lower than the level of the item which is currently used by the client, the processor 410 may determine that the item used by the client satisfies the condition.

When the client uses the item satisfying the condition, the processor 410 may process the event using the item which is currently used by the client in operation 713. According to one embodiment, the processor 410 may determine that the current amount of service use does not influence processing of the event of the client, the processor 410 may process the event using the item (for example, a fishing rod) which is currently used by the client as shown in FIG. 8A (800).

According to certain embodiments, when the client does not use the item satisfying the condition, the processor 410 may recommend an appropriate item to the client based on the amount of service use in operation 707. According to one embodiment, the processor 410 may select and recommend an item corresponding to the best level of the item corresponding to the amount of service use from among the items that the client has. For example, the processor 410 may determine that the current amount of service use influences processing of the event of the client, and may recommend an item 812 appropriate to the current client as shown in FIG. 8B (810).

In some embodiments, at operation 709, the processor 410 may determine whether an item change request is received from the client. According to one embodiment, the item change request may be a request for changing the item currently used by the client to the recommended item.

When the item change request is not received, the processor 410 may process the event using the item which is currently used by the client. According to one embodiment, the processor 410 may perform an operation related to operation 713.

When the item change request is received, the processor 410 may, according to embodiments, process the event using the changed item in operation 711.

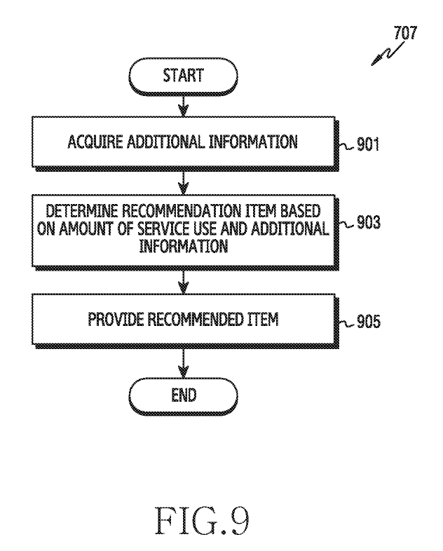

FIG. 9 illustrates, in flowchart format, an item recommending operation of an electronic device according to various embodiments of the present disclosure. According to at least one embodiment, the item recommending operation of the electronic device may correspond to an operation such as operation 707 described in FIG. 7.

Referring to FIG. 9, the processor 410 may, in certain embodiments, acquire additional information on the client in operation 901. According to one embodiment, the additional information may include age or sex of a user of the client or a characteristic of the character.

According to some embodiments, at operation 903, the processor 410 may recommend an item to the client based on the amount of service use and the additional information. According to one embodiment, the processor 410 may monitor a gaming method of each client and may analyze an item which, in this particular example, is mainly used by male users, an item which is mainly used by female users, and an item which is mainly used by each character. For example, the processor 410 may select an item corresponding to the additional information from among the items that the client has, based on a result of analyzing.

In some embodiments, at operation 905, the processor 410 may provide information on the recommended item to the client.

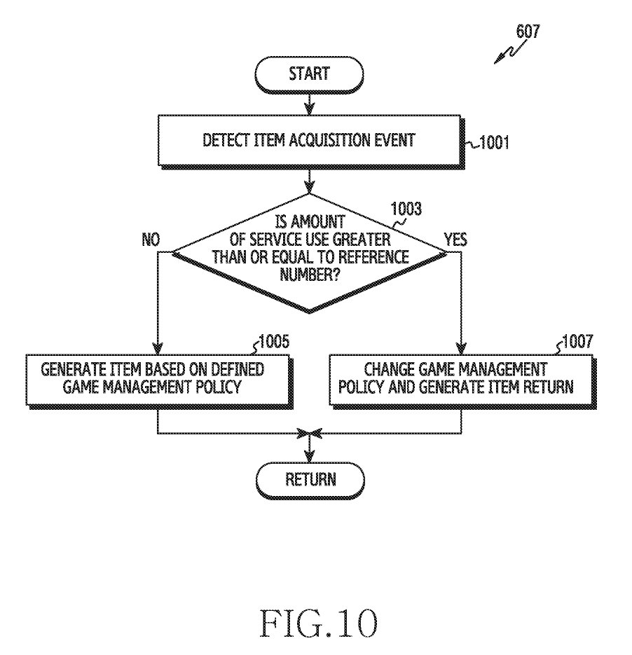

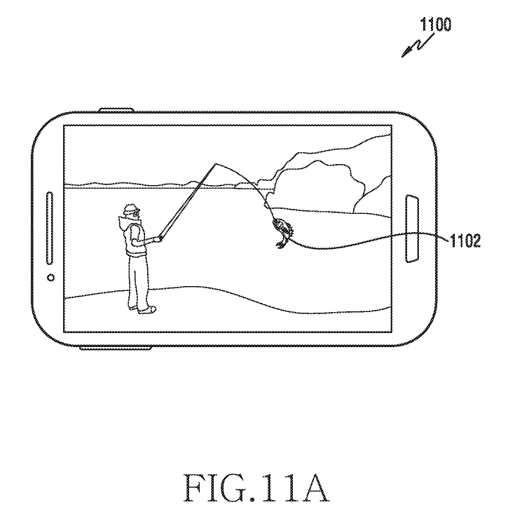

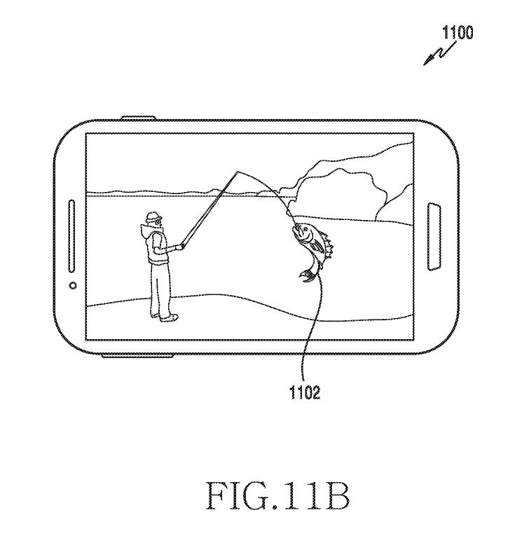

FIG. 10 illustrates, in flowchart format, an event processing operation of an electronic device according to various embodiments of the present disclosure. FIGS. 11A and 11B illustrate aspects of an example of the event processing operation according to various embodiments of the present disclosure. According to at least one embodiment, the event processing operation of the electronic device may be an operation such as operation 607 described in FIG. 6.

Referring to FIG. 10, the processor 410 may, in some embodiments, detect an item acquisition event in operation 1001. According to some embodiments, the item acquisition event may be an event in which an item is acquired using an object (for example, a character) controlled by the client. For example, the processor 410 may detect that the item acquisition event is generated in response to the client (or the object) entering an item generation region which is designated in the game.

In operation 1003, the processor 410 may determine an amount of service use regarding a location of the client. According to at least one embodiment, the processor 410 may determine whether the amount of service use exceeds a pre-designated reference value.

When the amount of service use does not exceed the pre-designated reference value, the processor 410 may generate an item based on a pre-defined game management policy (for example, an item generation policy) in operation 1005. According to some embodiments, the processor 410 may generate an item 1102 which is determined based on the pre-defined game management policy at the location of the client (1100) as shown in FIG. 11A.

When the amount of service use exceeds the pre-designated reference value, the processor 410 may, according to embodiments, change at least a portion of the pre-defined game management policy and may generate an item in operation 1007. According to one embodiment, the processor 410 may generate an item 1102 which is determined based on the changed game management policy at the location of the client (1110) as shown in the non-limiting example of FIG. 11B. For example, the processor 410 may generate an item of a higher grade than when the game management policy is not changed.

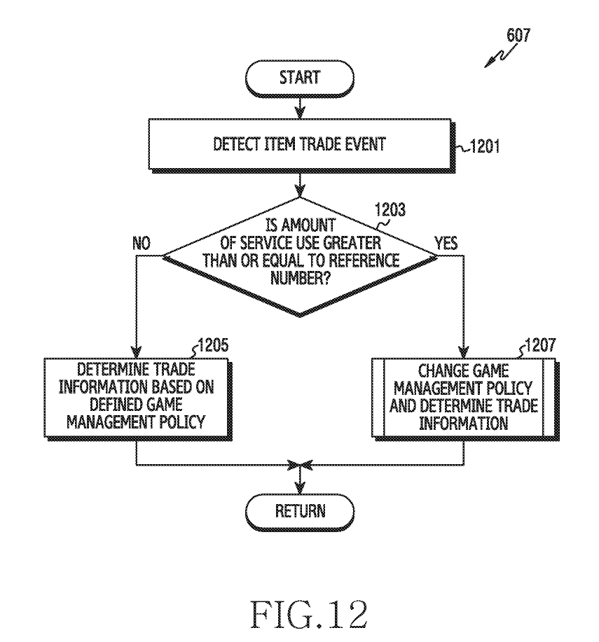

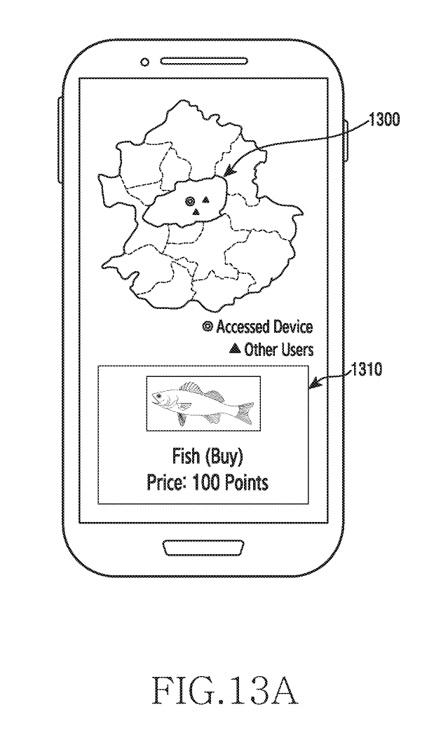

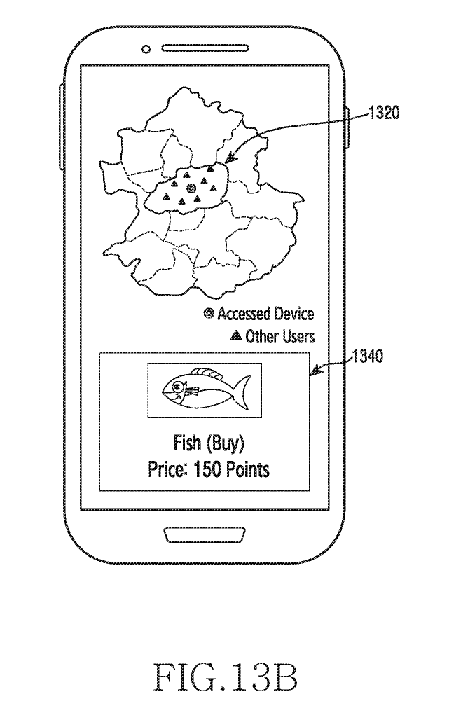

FIG. 12 illustrates, in flowchart format, an event processing operation of the electronic device according to various embodiments of the present disclosure. In addition, FIGS. 13A and 13B illustrate aspects of an example of the event processing operation according to various embodiments of the present disclosure. According to at least one embodiment, the event processing operation of the electronic device may be an operation such as operation 607 described in FIG. 6.

Referring to FIG. 12, the processor 410 may, according to certain embodiments, detect that an item trade event is generated in operation 1201. According to some embodiments, the item trade event may be an event in which the client trades with another client on an item on the game. For example, when the client (or object) enters a designated trade region, the processor 410 may detect that the item trade event is generated. Furthermore, the processor 410 may extract information on a trade item corresponding to the location of the client from a database in which items traded in each region are defined.

According to certain embodiments, at operation 1203, the processor 410 may determine an amount of service use on the location of the client. According to one embodiment, the processor 410 may determine whether the amount of service use exceeds a pre-designated reference value.

When the amount of service use does not exceed the pre-designated reference value, the processor 410 may, according to embodiments, determine item trade information (for example, a price of a trade item, a number of trade items, or the like) based on a pre-defined game management policy (for example, a trade policy). According to at least one embodiment, the processor 410 may process the item trade event using the item trade information which is determined based on the pre-defined game management policy. For example, as shown in FIG. 13A, when the number of clients positioned in the trade region is less than a predetermined reference (1300), the processor 410 may determine that the trade price is not influenced and may determine trade information based on the pre-defined game management policy (1310).

When the amount of service use exceeds the pre-designated reference value, the processor 410 may, depending on embodiments, change at least a portion of the pre-defined game management policy and may determine item trade information in operation 1207. According to one embodiment, the processor 410 may process the item trade event using item trade information which is determined based on the changed game management policy. For example, as shown in FIG. 13B, when the number of clients positioned in the trade region is greater than or equal to the predetermined level (1320), the processor 410 may determine that the trade price is influenced, and may change the pre-defined game management policy and may increase the trade price (1340).

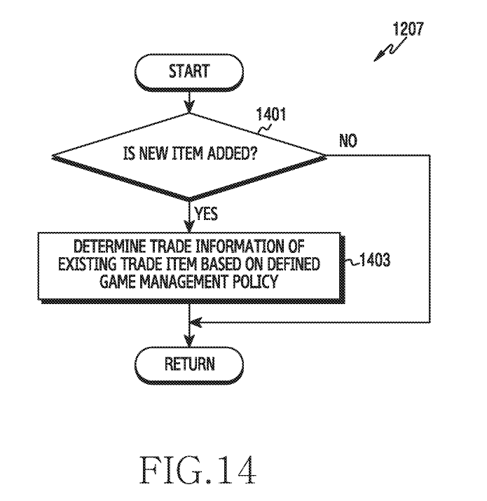

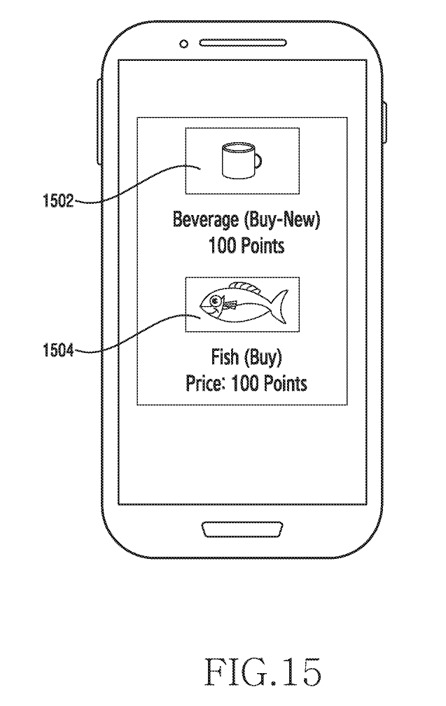

FIG. 14 illustrates, in flowchart format, a trade information determining operation of an electronic device according to various embodiments of the present disclosure. FIG. 15 illustrates aspects of an example of the trade information determining operation according to various embodiments of the present disclosure. According to at least one embodiment, the trade information determining operation of the electronic device may be an operation corresponding to operation 1207 described in FIG. 12.

Referring to the non-limiting example of FIG. 14, in operation 1401, the processor 410 may determine whether a new trade item is added while processing the item trade event. According to certain embodiments, when a new item is produced in the region in which the client (object) proceed with trading according to the game management policy, the processor 410 may determine that a new trade item is added. In addition, when another client having a new item tries to trade in the region in which the client (or object) proceeds with trading, the processor 410 may determine that the new trade item is added.

When a new trade item is not added, the processor 410 may, according to some embodiments, change at least a portion of the pre-defined game management policy, and may determine item trade information.

When the new trade item is added, the processor 410 may determine trade information on an existing trade item based on the pre-defined game management policy in operation 1403. According to some embodiments, the processor 410 may determine that a value of the existing trade item may be depreciated as the new trade item is added (1502), and may reduce the price of the existing trade item which had been increased (1504).

According to various embodiments, an operating method of an electronic device includes communicating with at least one client, generating an event based on a location of the at least one client and a game management policy which is stored in the electronic device; and, while generating the event, determining an amount of service use corresponding to the location, and, when the amount of service use exceeds a reference value, changing at least a portion of the game management policy.

According to various embodiments, the location of the at least one client may include information on a geographical location where the at least one client is positioned.

According to various embodiments, changing the game management policy may include changing trade information on an item which is traded on a game service.

According to various embodiments, changing the trade information on the item may include changing the game management policy based on an item which is newly added in the location of the at least one client.

According to various embodiments, the trade information of the item may include at least one of a type of a trade item, a number of trade items, and a price of a trade item.

According to various embodiments, changing the game management policy may include changing an attribute of an item to be acquired by the at least one client.

According to various embodiments, the operating method of the electronic device may further include recommending an item to be used by the at least one client based on the amount of service use corresponding to the location.

According to various embodiments, recommending the item may include acquiring profile information on the at least one client, and recommending an item to be used by the at least one client based on the acquired profile information.

According to various embodiments, the amount of service use may include a number of concurrent users accessing the location of the at least one client.

The electronic device and the operating method thereof according to various embodiments of the present disclosure provide a game service which changes an event processing method based on a geographical location of a client and another client positioned on the periphery of the client, such that users can be provided with more interest by the game service than by an existing game service which generates an event according to a defined game policy.

While the present disclosure has been shown and described with reference to certain embodiments thereof, it will be apparent to those skilled in the art that the present disclosure is not limited to these embodiments, and various changes in form and details may be made therein without departing from the spirit and scope of the present disclosure as defined by the appended claims.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. An electronic device comprising:
a communication unit configured to communicate with at least one client;
a memory configured to store a game management policy; and
a processor configured to generate an event based on a location of the at least one client using a game service, and the stored game management policy,
wherein the processor is configured to:
determine an amount of service use corresponding to the location while generating the event, and,
when the amount of service use exceeds a reference value, change at least a portion of the game management policy.

2. The electronic device of claim 1, wherein the processor is configured to determine a geographical location where the at least one client is positioned.

3. The electronic device of claim 1, wherein the processor is configured to change the game management policy and to change trade information on an item which is traded on the game service.

4. The electronic device of claim 3, wherein the processor is configured to change the game management policy based on an item which is newly added in the location of the at least one client.

5. The electronic device of claim 3, wherein the trade information of the item comprises at least one of a type of a trade item, a number of trade items, and a price of a trade item.

6. The electronic device of claim 1, wherein the processor is configured to change the game management policy and to change an attribute of an item to be acquired by the at least one client.

7. The electronic device of claim 1, wherein the processor is configured to recommend an item to be used by the at least one client based on the amount of service use corresponding to the location.

8. The electronic device of claim 7, wherein the processor is configured to acquire additional information on the at least one client, and to recommend an item to be used by the at least one client.

9. The electronic device of claim 1, wherein the processor is configured to calculate the amount of service use based on a number of concurrent users accessing the location of the at least one client.

10. The electronic device of claim 1, wherein the electronic device comprises a service server.

11. A method for operating an electronic device, the method comprising:
communicating with at least one client;
generating an event based on a location of the at least one client and a game management policy which is stored in the electronic device;
while generating the event, determining an amount of service use corresponding to the location; and
when the amount of service use exceeds a reference value, changing at least a portion of the game management policy.

12. The method of claim 11, wherein the location of the at least one client comprises information on a geographical location where the at least one client is positioned.

13. The method of claim 11, wherein changing the game management policy comprises changing trade information on an item which is traded on a game service.

14. The method of claim 13, wherein changing the trade information on the item comprises changing the game management policy based on an item which is newly added in the location of the at least one client.

15. The method of claim 13, wherein the trade information of the item comprises at least one of a type of a trade item, a number of trade items, and a price of a trade item.

16. The method of claim 11, wherein changing the game management policy comprises changing an attribute of an item to be acquired by the at least one client.

17. The method of claim 11, further comprising recommending an item to be used by the at least one client based on the amount of service use corresponding to the location.

18. The method of claim 16, wherein recommending the item comprises acquiring profile information on the at least one client, and recommending an item to be used by the at least one client based on the acquired profile information.

19. The method of claim 11, wherein the amount of service use comprises a number of concurrent users accessing the location of the at least one client.

20. A computer-readable recording medium which stores a program for executing:
communicating with at least one client;
generating an event based on a location of the at least one client and a game management policy which is stored in the electronic device;
while generating the event, determining an amount of service use corresponding to the location; and
when the amount of service use exceeds a reference value, changing at least a portion of the game management policy.
